(19) United States
(12) Patent Application Publication
(10) Pub. No.: US 2026/0080736 A1
(43) Pub. Date: Mar. 19, 2026

(54) Autonomous Food Vending Machine with Cold Storage, On-Demand Heating, and Personalized Meal Recommendation System

(71) Applicant: Frank Agyei-Ntim, Ridgeland, MS (US)

(72) Inventor: Frank Agyei-Ntim, Ridgeland, MS (US)

(21) Appl. No.: 19/325,655

(22) Filed: Sep. 11, 2025

Related U.S. Application Data
(60) Provisional application No. 63/695,387, filed on Sep. 17, 2024.

(51) Int. Cl. G07F 17/00; G07F 11/16; G07F 11/72

(52) U.S. Cl. CPC G07F 17/0078; G07F 11/16; G07F 11/72

(57) ABSTRACT

An autonomous food vending machine that dispenses contamination-free cooked meals while preserving taste and nutritional value is disclosed. The machine comprises a housing with a touchscreen interface, secure payment modules, a dispensing slot, and dual hinged doors for bi-directional loading. A storage chamber contains vertically aligned modular trays, each tray holding sealed food cartridges supported by dividers and rollers for smooth movement. A cold chamber preserves freshness until an autonomous dispensing system or mechanism transfers a selected cartridge into a heating chamber, where it is warmed before vending. The modular tray assembly enables flexible cartridge organization and rapid restocking. In some embodiments, the vending machine integrates a personalized meal recommendation system including a processor, database, recommendation engine, and electronic health record module. This system enables clinicians to prescribe diet plans remotely and dynamically update user meal choices, thereby providing health-tailored nutrition directly through the vending platform.

### CROSS-REFERENCE TO RELATED APPLICATION

The present application claims priority to, and the benefit of, U.S. Provisional Application No. 63/695,387 which was filed on Sep. 17, 2024 and is incorporated herein by reference in its entirety.

### FIELD OF THE INVENTION

The present invention generally relates to automated (i.e., autonomous) food vending systems. More specifically, the present invention relates to an automated (i.e., autonomous) food vending machine configured with dual-chamber storage, modular tray assemblies, and an on-demand heating system designed to eliminate the shortcomings of conventional vending machines. The invention comprises a housing having a front-facing touchscreen interface for menu selection and payment, a dispensing slot for delivering meals, and dual hinged access doors for restocking. A plurality of modular trays are disposed within a cold storage chamber, each tray configured to hold sealed food cartridges and equipped with rollers and dividers to maintain stability during automated (i.e., autonomous) movement. Upon user selection and payment, a dispensing mechanism retrieves the appropriate food cartridge, transfers it to a heating chamber, and warms the meal before dispensing the food cartridge through the outlet. Accordingly, the present disclosure makes specific reference thereto. Nonetheless, it is to be appreciated that aspects of the present invention are also equally applicable to other like applications, devices, and methods of manufacture.

### BACKGROUND

By way of background, vending machines are commonly used to provide convenient access to meals and snacks for individuals who are traveling, at work, or otherwise away from home without immediate access to food. While vending machines are valued for their accessibility and speed of service, the food products typically offered are often pre-packaged, highly processed, or of limited nutritional value. As a result, consumers are frequently restricted to snacks, fast food items, or beverages that may not support balanced dietary needs.

Another drawback of conventional vending machines is that the food stored therein may lack freshness and quality comparable to a home-cooked meal. Items stored for extended periods of time inside the machine can become stale, lose their natural taste, and, in some cases, become prone to contamination. The items can create both health concerns and negative user experiences. Accordingly, there is a growing demand for vending solutions that can provide fresh, contamination-free meals with the taste, nutrition, and quality associated with home cooking.

Therefore, there exists a long-felt need in the art for an automated (i.e., autonomous) food vending machine that eliminates the shortcomings of conventional vending machines. There is a need for a vending system that can provide consumers with contamination-free, home-cooked style meals while preserving the original taste and nutritional value over extended periods of time. Further, there is a need for vending machines that store and deliver food in a manner that ensures freshness, prevents staleness, and avoids contamination caused by prolonged storage. Additionally, there exists a need for vending machines that provide a greater variety of healthy meal options, including meals recommended for individuals with specific health conditions, rather than limiting customers to processed snacks and fast food. Finally, there is a need in the art for a vending solution that integrates with healthcare platforms to provide personalized dietary recommendations and/or requirements, thereby extending the utility of vending machines beyond convenience into health and wellness.

The subject matter disclosed and claimed herein, in one embodiment, comprises an automated (i.e., autonomous) food vending machine featuring a housing with a touchscreen interface, secure payment systems, dual hinged doors (i.e., gullwing doors) for convenient restocking, a cold storage chamber, and an on-demand heating chamber. The vending machine further comprises a plurality of modular tray assemblies, each configured with rollers, dividers, and handles for smooth insertion and removal, and operable to hold a plurality of sealed food cartridges. The food cartridges are preserved in the cold chamber until selected by a user, at which point an autonomous dispensing system or mechanism transfers the cartridge into the heating chamber. The heating chamber warms the meal to an optimal serving temperature before dispensing it through a controlled outlet slot, thereby providing the user with a hot and contamination-free meal.

In one embodiment, the vending machine integrates a personalized meal recommendation module including a processor, database, recommendation engine, and electronic health record connectivity. The system enables customers to register with the machine and receive meal suggestions tailored to their health needs, such as low-glycemic index meals for diabetic users or reduced-sodium meals for hypertensive individuals. In another embodiment, clinicians and dietitians may remotely prescribe diet plans that are synchronized with the vending machine's menu.

In this manner, the automated (i.e., autonomous) food vending machine of the present invention addresses longstanding shortcomings in conventional vending machines by providing fresh, safe, and nutritionally balanced meals rather than processed or stale snacks. The invention combines modular cartridge-based cold storage with automated (i.e., autonomous) retrieval and on-demand heating to preserve taste and freshness until the moment of vending. The apparatus enhances food safety, expands healthy eating access, and delivers improved consumer confidence while also supporting medical nutrition therapy in real-world environments such as workplaces, hospitals, and travel hubs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automated (i.e., autonomous) food vending machine. The vending machine comprises a housing fabricated from sheet metal or polymer composite material with a corrosion-resistant finish, the housing includes a touchscreen, a card reader slot, a cash input slot, a dispensing slot, and a pair of opposite hinged gullwing doors. The vending machine further comprises a storage chamber disposed within the housing and configured to store a plurality of meal trays aligned vertically, each meal tray includes a tray body, a plurality of dividers, a plurality of rollers, and configured to hold modular food cartridges. The vending machine further comprises a cold chamber associated with the storage chamber for preserving the food cartridges at predetermined cold temperatures, an autonomous dispensing system or mechanism including dispensing arms configured to retrieve a selected food cartridge from one of the meal trays, and a heating chamber including a heater operable to heat the selected food cartridge before transferring the heated food cartridge to the dispensing slot for vending to a user.

In another embodiment, a method for dispensing meals from an automated (i.e., autonomous) food vending machine is described and comprises the steps of displaying, on a touchscreen, a plurality of menu items each represented by an image and associated pricing, receiving a user selection of a food item and verifying payment through a card reader slot or a cash input slot, automatically maneuvering a selected tray from a storage chamber containing a plurality of food cartridges, transferring the selected food cartridge into a heating chamber, heating the food cartridge using a heater within the heating chamber, and dispensing the heated food cartridge through a dispensing slot, thereby providing a contamination-free, freshly heated meal to the user.

In one embodiment, the automated (i.e., autonomous) food vending machine provides personalized meal recommendation and includes a recommendation engine operable to generate personalized meal options for customers based on health conditions, a processor configured to coordinate user interactions, payment verification, data retrieval, and updates to the recommendation engine, and a database configured to store nutritional details of meals, user profiles, and clinician-prescribed diet plans. The vending machine further comprises an Electronic Health Record module enabling integration with external healthcare platforms, wherein clinicians may remotely prescribe diet plans that are synchronized with the vending machine. The vending machine dynamically updates the touchscreen to display recommended meal options based on user health data and further transmits adherence data and purchase history back to the clinician for monitoring.

In another embodiment, the modular tray assembly for use in the automated (i.e., autonomous) food vending machine comprises a tray body fabricated from food-grade sheet metal or corrosion-resistant alloy, the tray body includes a plurality of removable dividers configured to partition the tray into sections for holding food cartridges. The modular tray assembly further comprises a plurality of rollers disposed on a bottom surface of the tray body configured to minimize friction during insertion and removal of the tray assembly, and a plurality of handles disposed at opposing ends of the tray body, the handles being operable for bi-directional insertion and removal of the tray assembly from the vending machine. The modular tray assembly is dimensioned to accommodate food cartridges of various dimensions, and the dividers are configured to maintain cartridge stability during tray movement and automated (i.e., autonomous) retrieval.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the automated (i.e., autonomous) food vending machine of the present invention in accordance with the disclosed structure;

FIG. 2 illustrates a perspective view of the automated (i.e., autonomous) food vending machine of the present invention with the dual doors in an open position in accordance with the disclosed structure;

FIG. 3 illustrates an exploded perspective view of the modular tray assembly employed within the vending machine of the present invention for storing and organizing food cartridges;

FIG. 4 illustrates an assembled view of the tray assembly with food cartridges loaded inside therein in accordance with the disclosed structure;

FIG. 5A illustrates a perspective view showing the vending machine in an idle state in accordance with the disclosed structure;

FIG. 5B illustrates a perspective view showing the position of the dispensing arms aligned with the selected tray in accordance with the disclosed structure;

FIG. 5C illustrates a perspective view showing the movement of the selected tray for dispensing in accordance with the disclosed structure;

FIG. 5D illustrates the position of the selected tray in the transfer slot for transferring the tray into the heating chamber in accordance with the disclosed structure;

FIG. 5E illustrates the position of the selected tray in the heating chamber for heating and dispensing in accordance with the disclosed structure; and

FIG. 6 illustrates a block diagram of the personalized meal recommendation module integrated within the vending machine of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an automated (i.e., autonomous) food vending machine that eliminates the shortcomings of conventional vending machines. There is a need for a vending system that can provide consumers with contamination-free, home-cooked style meals while preserving the original taste and nutritional value over extended periods of time. Further, there is a need for vending machines that store and deliver food in a manner that ensures freshness, prevents staleness, and avoids contamination caused by prolonged storage. Additionally, there exists a need for vending machines that provide a greater variety of healthy meal options, including meals recommended for individuals with specific health conditions, rather than limiting customers to processed snacks and fast food. Finally, there is a need in the art for a vending solution that integrates with healthcare platforms to provide personalized dietary recommendations and/or requirements, thereby extending the utility of vending machines beyond convenience into health and wellness.

The present invention, in one exemplary embodiment, is a method for dispensing meals from an automated (i.e., autonomous) food vending machine is described and comprises the steps of displaying, on a touchscreen, a plurality of menu items each represented by an image and associated pricing, receiving a user selection of a food item and verifying payment through a card reader slot or a cash input slot, automatically maneuvering a selected tray from a storage chamber containing a plurality of food cartridges, transferring the selected food cartridge into a heating chamber, heating the food cartridge using a heater within the heating chamber, and dispensing the heated food cartridge through a dispensing slot, thereby providing a contamination-free, freshly heated meal to the user.

Reference will now be made in detail to the present preferred embodiments of the invention, examples of which are illustrated in the accompanying drawings. Wherever possible, the same reference numerals are used in the drawings and the description to refer to the same or like parts.

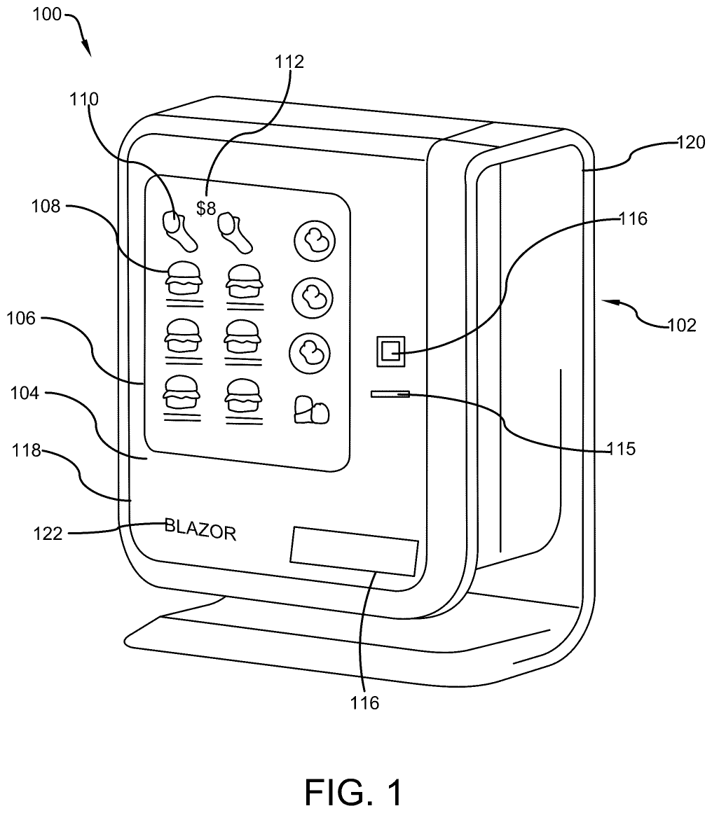

Referring initially to the drawings, FIG. 1 illustrates a perspective view of the automated (i.e., autonomous) food vending machine of the present invention in accordance with the disclosed structure. The automated (i.e., autonomous) food vending machine 100 of the present invention is designed to dispense contamination-free, home-cooked meals while preserving their original taste and nutritional value for extended periods. The automated (i.e., autonomous) food vending machine 100 includes a plurality of cold and warm chambers, food cartridges, and an on-demand heating mechanism (i.e., microwave or air-fryer) to deliver fresh, hot meals instantly. More specifically, the automated (i.e., autonomous) food vending machine 100 comprises a housing 102 that includes a plurality of functional components for food storage, the heating mechanism, and a dispensing mechanism as described later in the disclosure. The housing 102 is generally rectangular (i.e., rectilinear) in shape and can have curved side edges. Further, the housing 102 is fabricated from sheet metal or polymer composite material with a corrosion-resistant finish. The housing 102 can have dimensions of about 1.0 to 2.0 meters in height, 0.5 to 1.0 meters in width, and 0.4 to 1.0 meters in depth, though dimensions and shape may vary without departing from the scope of the invention.

The front surface 104 of the housing 102 has a touchscreen 106 for enabling users to view and select one or more food items. The touchscreen 106 may display a menu grid 108 of a plurality of food items such as sandwich wraps, burgers, pastries, fruits, and other food and beverages. Each menu item can be represented by an image 110 and associated pricing 112. The touchscreen 106 can be a capacitive display with anti-glare and antimicrobial coating to reduce contamination risk. It should be noted that the touchscreen 106 serves both as a user interface for selecting meals and as a status display for payment confirmation, dietary recommendations and/or requirements, and operational messages.

A card reader slot 114 is disposed in the housing 102 and is configured to accept debit, credit, and near field communication (NFC) enabled payment cards. The card reader 114 may be equipped with EMV-compliant technology for secure transactions and contactless payment support. A cash input slot 115 is also included in the housing 102 for enabling users to make transactions using cash.

A dispensing slot 116 is disposed in the front surface 104, preferably below the touchscreen 106 and is configured to autonomously dispense a meal. The dispensing slot 116 may include a swinging flap door or sliding shutter mechanism, thereby making the food accessible once the heating and vending cycle are complete.

The housing 102 has a pair of opposite (i.e., opposing) hinged gullwing doors 118, 120 for providing access to the food cartridge loading chamber as described later in the disclosure. The dual-door design of the housing 102 permits staff to stock food trays or cartridges from either side, thereby improving workflow efficiency. It should be noted that the doors 118, 120 are lockable and may be equipped with electronic access control for security and for authorized access. A logo or indicia 122 is affixed or embossed on the front surface 104 for marketing and branding purposes.

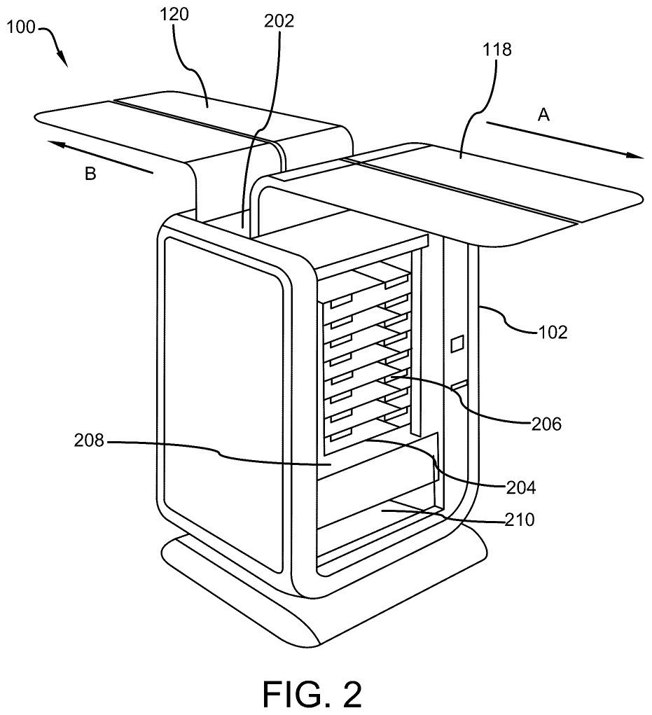

FIG. 2 illustrates a perspective view of the automated (i.e., autonomous) food vending machine of the present invention with the dual doors in an open position in accordance with the disclosed structure. The doors 118, 120 are configured to be hinged along the top end 202 of the housing 102. The doors 118, 120 extend in opposite directions (shown through arrows A and B) in the open state for providing dual access from either side of the housing 102 to enable loading and unloading of a plurality of meal tray assemblies 204 and food cartridges 206. The doors 118, 120 may be fabricated from sheet metal or high-strength polymer composite and can be insulated to reduce condensation.

The housing 102 includes a storage chamber 208 to store the plurality of meal trays 204 which are aligned vertically in the storage chamber 208. Each tray of the plurality of meal trays 204 is designed to hold modular food cartridges 206, which can contain pre-packaged meals sealed for freshness. Trays 204 may be made of food-grade stainless steel or coated sheet metal and can be mounted on roller-guided rails to enable smooth insertion and removal as described later in the disclosure.

A dispensing area (i.e., dispenser) 210 operatively connected to the dispensing slot 116 (FIG. 1) is provided at the bottom of the storage chamber 208. The dispenser 210 provides the pathway through which meals are transferred from the meal trays 204 to a heating chamber and subsequently to the customer via the dispensing slot (FIG. 1).

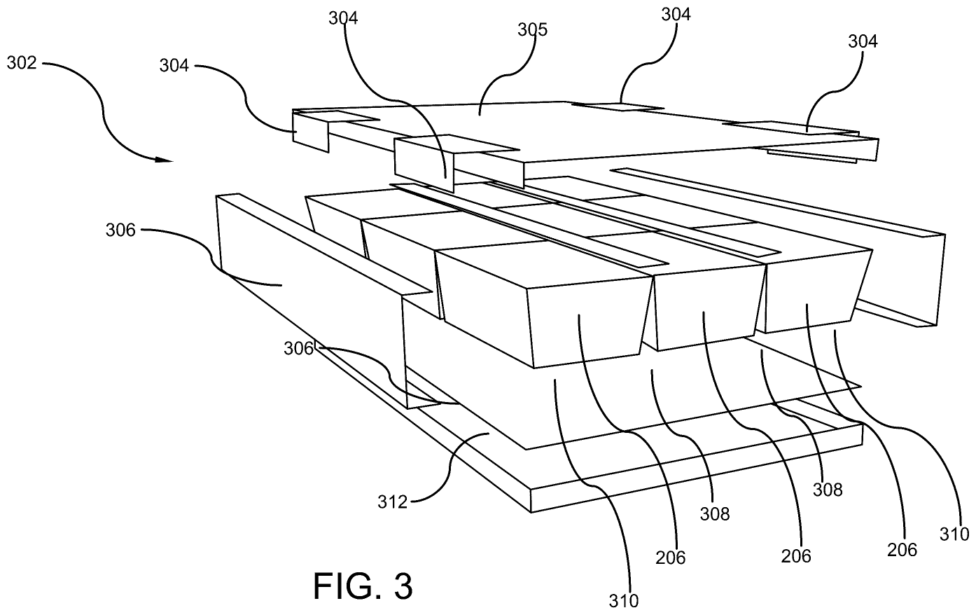

FIG. 3 illustrates an exploded perspective view of the modular tray assembly employed within the vending machine of the present invention for storing and organizing food cartridges. The tray assembly is designed to facilitate efficient loading, storage, and automated (i.e., autonomous) retrieval of pre-packaged meals while maintaining hygiene and minimizing mechanical friction. The tray assembly 302 (one of the tray assemblies 204 of FIG. 2) includes a plurality of handles 304, preferably located at both the front and rear ends of the top panel 305 of the tray body 306 for easy insertion and removal of the tray assembly 302 from either side of the machine (via the gullwing doors 118, 120 of FIG. 2). Each handle is preferably constructed from sheet metal or high-strength polymer and may be coated with anti-slip or antimicrobial material to enhance operator safety and food hygiene.

The tray body 306 is fabricated from food-grade sheet metal or corrosion-resistant alloy and provides the structural base for holding a plurality of meal cartridges 206. The tray body 306 includes a plurality of removable dividers 308, which are designed to partition the tray body 306 into a plurality of sections 310 for housing individual food cartridges. The dividers 308 provide arrangement and prevent food cartridges from colliding or shifting during tray movement and enable for precise retrieval for dispensing.

A plurality of rollers 312 are disposed on the bottom surface of the tray body 306. The rollers 312 are configured to minimize friction during insertion, removal, and automated (i.e., autonomous) movement of the tray assemblies inside the storage chamber.

In use, operators of the vending machine 100 insert pre-packed meal cartridges 206 into the tray body 306, separating the pre-packed meal cartridges 206 with dividers 308. The tray can then be slid into the cold chamber of the vending machine and the rollers 312 provide smooth handling, while dividers maintain cartridge stability.

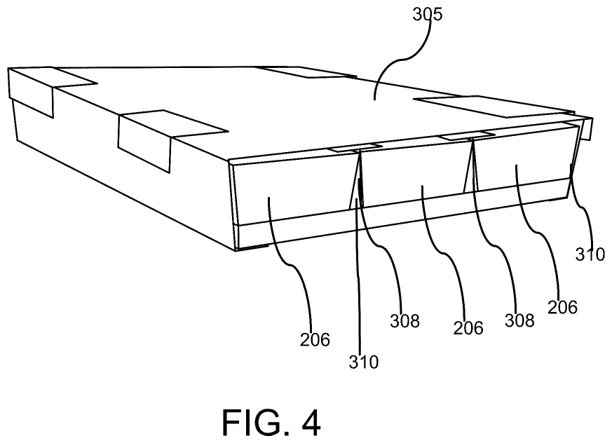

FIG. 4 illustrates an assembled view of the tray assembly with food cartridges loaded inside therein in accordance with the disclosed structure. In the assembled state, the food cartridges 206 are arranged in the sections 310 and each cartridge is dimensioned to fit snugly within the tray assembly, supported by dividers (FIG. 3). The top panel 305 of the tray body 306 prevents the food cartridges from physical damage and enables smooth movement of the cartridges along the tray body 306. The tray assembly 302 is modular and can be dimensioned to accommodate cartridges of various dimensions.

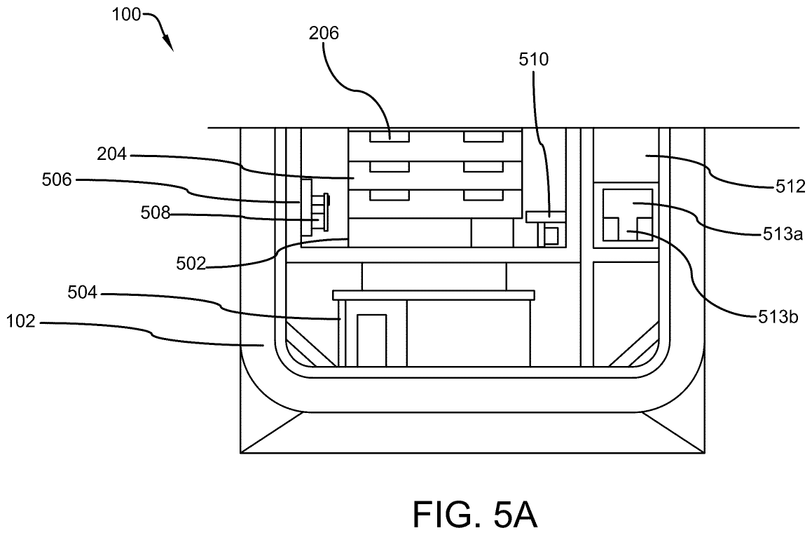

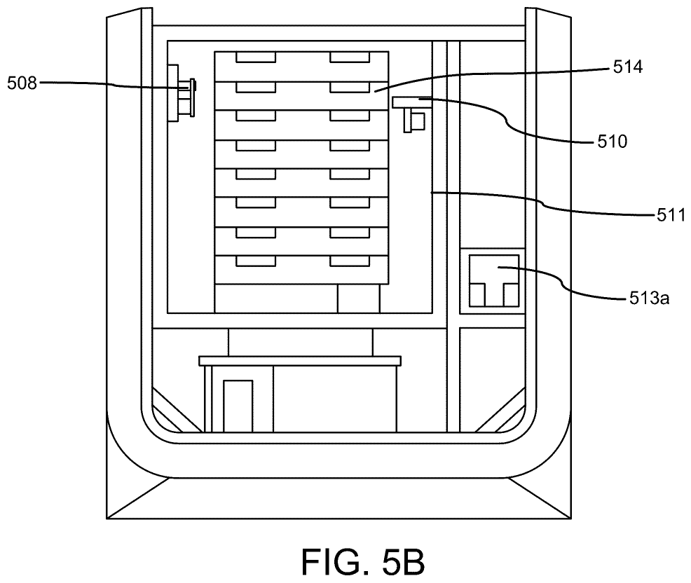

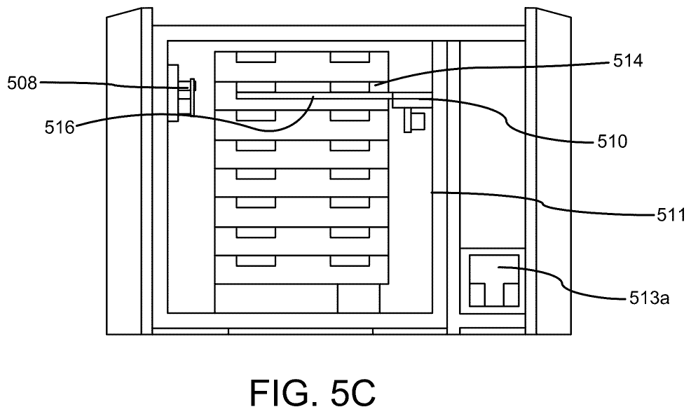

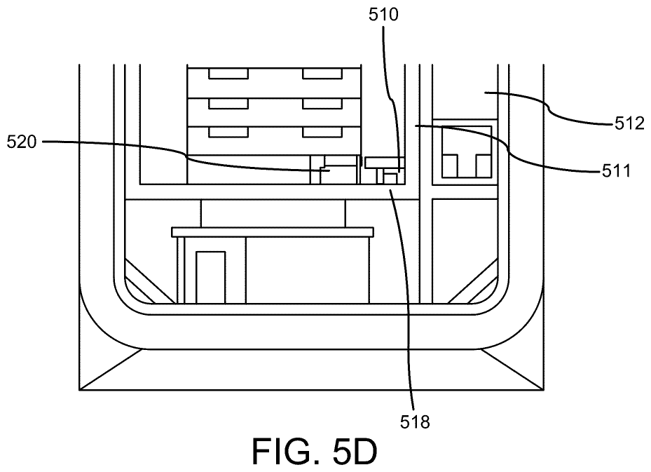

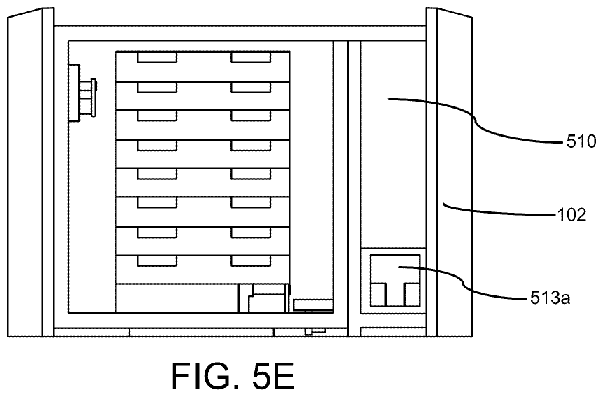

FIGS. 5A-5E illustrate states of the vending machine in the sequential operational stages of the vending machine in accordance with the disclosed structure. In FIG. 5A, the vending machine 100 is in an initial idle state and the plurality of trays 204 are stacked vertically within a cold chamber 502 of the storage chamber 208. Each tray of the plurality of trays 204 hold food/meal cartridges 206. It should be noted that there is no movement in the trays within the cold chamber 502 until a request is received from a user for dispensing the food. The cold chamber 502 remains frozen using a freezing system 504 which is configured to freeze the food items to maintain their freshness while improving the shelf life.

The trays 204 are configured to be automatically maneuvered within the housing 102 for dispensing using an autonomous dispensing system or mechanism 506. The autonomous dispensing system or mechanism 506 includes a pair of dispensing arms 508, 510 for transferring a food cartridge to a heating chamber 512. The heating chamber 512 includes a heater, air-fryer, or microwave 513a for heating the food cartridges before dispensing from the dispensing slot (FIG. 1). Further, the heater, air-fryer, or microwave 513a also includes a piston 513b for movement of the food cartridges to the dispensing slot for dispensing hot and fresh food items.

FIG. 5B illustrates a perspective view showing the position of the dispensing arms aligned with the selected tray in accordance with the disclosed structure. When an input for a meal is received from the touchscreen (such as described in FIG. 1), the automated (i.e., autonomous) dispensing arms 508, 510 automatically move along the conveyor belt 511 for positioning along the selected tray 514 (in the present embodiment). It should be noted that the trays are stacked vertically which enables the dispensing arms 508, 510 to move simultaneously and vertically to align with the selected tray.

FIG. 5C illustrates a perspective view showing the movement of the selected tray for dispensing in accordance with the disclosed structure. As illustrated, the dispensing arms 508, 510 are positioned along the selected tray 514 and a transfer rack 516 extends to remove the selected tray 514. The rollers (FIG. 3) enable smooth tray movement with minimal friction while the dividers within the tray maintain proper cartridge alignment during the motion of the selected tray.

FIG. 5D illustrates the position of the selected tray in the transfer slot for transferring the tray into the heating chamber in accordance with the disclosed structure. The dispensing arms 508, 510 remove the selected tray 514 as illustrated in FIG. 3 and then, the dispensing arm 510 vertically slides along the conveyor belt 511 to position the tray 514 in the transfer slot 518 where a transfer member 520 is configured to push the tray 514 into the heating chamber 512.

FIG. 5E illustrates the position of the selected tray in the heating chamber for heating and dispensing in accordance with the disclosed structure. The food cartridge of the selected tray 514 is transferred to the heating chamber 512 as described in FIG. 5D and is then heated using the heater, air-fryer, or microwave 513a. The food cartridge is then pushed down towards the dispensing slot (not shown in FIG. 5E) for dispensing. It should be noted that the temperature and duration for cooling and heating can be predetermined and further can be based on the type of food items.

The vending machine 100 of the present invention provides contamination-free delivery as the meals remain sealed within cartridges until vending, thereby reducing exposure to contaminants. Further, the cold chamber maintains freshness and natural taste, while the heating process maintains the taste. In some embodiments, the vending machine 100 can recommend meals tailored to customers with specific health conditions (i.e., diabetes, obesity, hypertension, cardiac issues).

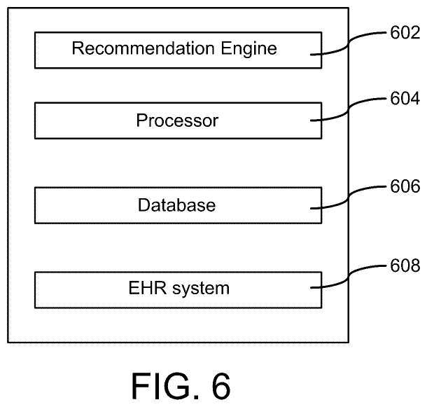

FIG. 6 illustrates a block diagram of the personalized meal recommendation module integrated within the vending machine of the present invention. The personalized meal recommendation module 600 is designed to process customer health data, generate meal recommendations, and synchronize clinician-prescribed diet plans with the menu options of the vending machine 100. The recommendation engine 602 is operable to generate personalized meal options for customers and may use artificial intelligence or machine learning models that evaluate the nutritional composition of available meals against the dietary requirements of individual users. As non-limiting examples, a diabetic user may be shown low glycemic index meals and a hypertensive user may be shown meals with reduced sodium content. The recommendation engine communicates directly with the processor 604 to dynamically update the meal selection touchscreen (FIG. 1) in real time.

The processor 604 is configured to coordinate user interactions, payment verification, data retrieval from the database 606, and updates to the recommendation engine. The processor 604 may be a microcontroller, microprocessor, or system-on-chip (SoC) embedded within the machine.

The database 606 is configured to store information such as nutritional details of meals stored in cartridges, user profiles and their preferences, and clinician-prescribed diet plans linked to registered users. The database 606 may be implemented as a local memory unit, a remote cloud server, or a hybrid system.

The Electronic Health Record (EHR) module 608 enables integration of the vending machine 100 with external healthcare platforms and clinicians and dietitians may prescribe diet plans remotely, which are then synced with the vending machine 100. The vending machine 100 also transmits meal purchase and adherence data back to the clinician for progress tracking and for recommendations of meals.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automated (i.e., autonomous) food vending machine”, “contamination-free vending apparatus”, “vending machine”, and “device” are interchangeable and refer to the automated (i.e., autonomous) food vending machine with integrated cold storage and on-demand heating 100 of the present invention.

Notwithstanding the forgoing, the automated (i.e., autonomous) food vending machine with integrated cold storage and on-demand heating 100 of the present invention can be of any suitable configuration as is known in the art without affecting the overall concept of the invention, provided that it accomplishes the above stated objectives. One of ordinary skill in the art will appreciate that the automated (i.e., autonomous) food vending machine with integrated cold storage and on-demand heating 100 shown in the FIGS. are for illustrative purposes only, and that many other configurations of the automated (i.e., autonomous) food vending machine with integrated cold storage and on-demand heating 100 are well within the scope of the present disclosure. Although the dimensions of the automated (i.e., autonomous) food vending machine with integrated cold storage and on-demand heating 100 are important design parameters for user convenience, the automated (i.e., autonomous) food vending machine with integrated cold storage and on-demand heating 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An autonomous food vending machine comprising:
a housing;
a touchscreen;
a food cartridge loading chamber; and
a plurality of meal trays;
wherein said housing comprising a cold chamber, a heating chamber, food cartridges, and a heating mechanism;
wherein said housing comprising a food storage and a dispensing mechanism;
wherein said touchscreen is on a front surface of said housing comprising a display menu grid of a plurality of food items;
wherein said plurality of food items selected from the group consisting of sandwich wraps, burgers, pastries, fruits, and beverages;
wherein each food item of said plurality of food items comprising an image and an associated price on said display menu grid;
wherein said touchscreen comprising a user interface for selecting said each food item of said plurality of food items and a status display selected from the group consisting of a payment confirmation, a dietary recommendation, and a dietary requirement;
wherein said housing comprising a dispensing slot disposed in a front surface of said housing configured to autonomously dispense said plurality of food items; and
further wherein said housing comprising a pair of opposing hinged doors for providing access to said food cartridge loading chamber.

2. The autonomous food vending machine of claim 1, wherein said housing comprising a card reader configured to accept a payment card selected from the group consisting of a debit card, a credit card, and a near field communication (NFC) enabled payment card.

3. The autonomous food vending machine of claim 2, wherein said housing comprising a cash input slot configured to accept cash from a user.

4. The autonomous food vending machine of claim 1, wherein each door of said pair of opposing hinged doors is a gullwing door pivotal along a top edge of said housing and extendable in opposite directions in an open state for providing dual access from either side of said housing.

5. The autonomous food vending machine of claim 1, wherein said housing comprising a storage chamber for storing said plurality of meal trays, and further wherein said plurality of meal trays are aligned vertically in said storage chamber.

6. The autonomous food vending machine of claim 5, wherein said at least one modular food cartridge is a pre-packaged meal.

7. The autonomous food vending machine of claim 6 further comprising a dispenser operatively connected to said dispensing slot and configured proximal to a bottom of said storage chamber, wherein said dispenser comprising a pathway through which said pre-packaged meals are transferred from said plurality of meal trays to said heating chamber.

8. The autonomous food vending machine of claim 7, wherein each tray of said plurality of meal trays comprising a tray body including a plurality of removable dividers configured to partition said each tray body into a plurality of sections for housing at least one modular food cartridge.

9. The autonomous food vending machine of claim 8, wherein said tray body including a plurality of rollers mounted on a bottom surface of said tray body configured to minimize friction during insertion, removal, and autonomous movement of the tray assemblies inside said storage chamber.

10. An autonomous food vending machine comprising:
a housing;
a touchscreen;
a food cartridge loading chamber;
a plurality of meal trays; and
a dispenser;
wherein said housing comprising a cold chamber, a heating chamber, food cartridges, and a heating mechanism;
wherein said housing comprising a food storage and a dispensing mechanism;
wherein said cold chamber is a freezer chamber;
wherein said touchscreen is on a front surface of said housing comprising a display menu grid of a plurality of food items;
wherein said plurality of food items selected from the group consisting of sandwich wraps, burgers, pastries, fruits, and beverages;
wherein each food item of said plurality of food items comprising an image and an associated price on said display menu grid;
wherein said touchscreen comprising a user interface for selecting said each food item of said plurality of food items and a status display selected from the group consisting of a payment confirmation, a dietary recommendation, and a dietary requirement;
wherein said housing comprising a dispensing slot disposed in a front surface of said housing configured to autonomously dispense said plurality of food items;
wherein said housing comprising a pair of opposing hinged doors for providing access to said food cartridge loading chamber;
wherein said dispenser operatively connected to said dispensing slot and configured proximal to a bottom of said storage chamber;
wherein said food cartridges are pre-packaged meals;
wherein said dispenser comprising a pathway through which said pre-packaged meals are transferred from said plurality of meal trays to said heating chamber; and
further wherein each tray of said plurality of meal trays comprising a tray body including a plurality of removable dividers configured to partition said each tray body into a plurality of sections for housing at least one modular said food cartridge.

11. The autonomous food vending machine of claim 10, wherein each door of said pair of opposing hinged doors is a gullwing door pivotal along a top edge of said housing and extendable in opposite directions in an open state for providing dual access from either side of said housing.

12. The autonomous food vending machine of claim 10, wherein said housing comprising a storage chamber for storing said plurality of meal trays, and further wherein said plurality of meal trays are aligned vertically in said storage chamber.

13. A method of dispensing food items from a food vending machine, the method comprising the steps of:
providing a housing, a touchscreen, a food cartridge loading chamber, a plurality of meal trays, and a dispenser;
wherein said housing comprising a freezer chamber, a heating chamber, food cartridges, a heating mechanism, a food storage, and a dispensing mechanism;
wherein said touchscreen is on a front surface of said housing comprising a display menu grid of a plurality of food items;
displaying an image of each food item of said plurality of food items and an associated price on said display menu grid;
loading said food cartridges into said freezer chamber;
selecting with a user interface on said touchscreen one or more of said each food item of said plurality of food items;
moving a selected said food item from said freezer chamber to said heating mechanism;
heating said food item in said heating mechanism; and
dispensing said food item with said dispensing mechanism through a dispensing slot in said housing.

14. The method of dispensing food items from a food vending machine of claim 13, wherein said plurality of food items selected from the group consisting of sandwich wraps, burgers, pastries, fruits, and beverages.

15. The method of dispensing food items from a food vending machine of claim 13, wherein said housing comprising a pair of opposing hinged gullwing doors for providing access to said food cartridge loading chamber.

16. The method of dispensing food items from a food vending machine of claim 13, wherein said dispenser comprising a pathway through which said pre-packaged meals are transferred from said plurality of meal trays to said heating chamber, and further wherein each tray of said plurality of meal trays comprising a tray body including a plurality of removable dividers configured to partition said each tray body into a plurality of sections for housing at least one modular said food cartridge.

17. The method of dispensing food items from a food vending machine of claim 13 further comprising a step of displaying a personalized dietary recommendation on said display menu grid, wherein said personalized dietary recommendation is based on user health data and synchronized clinician-prescribed diet plans with said plurality of food items.

18. The method of dispensing food items from a food vending machine of claim 13, wherein said dispenser comprising a pair of dispensing arms for transferring said food cartridges into said heating chamber.

19. The method of dispensing food items from a food vending machine of claim 18, wherein said heating element selected from the group consisting of a heater, an air-fryer, and a microwave.

20. The method of dispensing food items from a food vending machine of claim 17 further comprising a step of providing a database to the food vending machine, wherein said database having information selected from the group consisting of said synchronized clinician-prescribed diet plans, Electronic Health Records of the user, said user health data, and nutritional details of said food cartridges.
